(19) United States
(12) Patent Application Publication
(10) Pub. No.: US 2011/0073439 A1
(43) Pub. Date: Mar. 31, 2011

(54) Aligning and Feeding Device

(75) Inventors: Yoshiyuki Ota, Osaka (JP); Tomoyuki Shimoguchi, Osaka (JP); Takahiro Takigawa, Osaka (JP)

(73) Assignee: DAIICHI JITSUGYO VISWILL CO., LTD., Osaka (JP)

(21) Appl. No.: 12/994,636

(22) PCT Filed: Jun. 2, 2009
(86) PCT No.: PCT/JP2009/060038

§ 371 Date: Nov. 24, 2010

(30) Foreign Application Priority Data
Jun. 9, 2008 (JP) 2008-150174

(51) Int. Cl. B65G 47/14

(52) U.S. Cl. 198/392

(57) ABSTRACT

An aligning and feeding device capable of reliably aligning objects having a plane shape with an unequal ratio of length to width longitudinally and feeding them is provided.

An aligning and feeding device has a rotary table 2 horizontally rotatable, drive means 3 for rotating the rotary table 2, a supply mechanism for supplying objects to be aligned onto the rotary table 2 and a guide mechanism 7 for defining a conveying path for the objects to be aligned conveyed by the rotary table 2. The guide mechanism 7 has an introduction guide 11, first pair of alignment guides 16, second pair of alignment guides 19 and pair of discharge guides 23 which each has a guide face and are disposed sequentially along the conveying path for the objects to be aligned. The first pair of alignment guides 16 and the second pair of alignment guides 19 each have an outer guide positioned so that a start point of its guide face is closer to the periphery of the rotary table 2 than an end point thereof, and an inner guide positioned so that a start point of its guide face is closer to the center of the rotary table 2 than an end point thereof.

### TECHNICAL FIELD

The present invention relates to an aligning and feeding device comprising a rotary table provided to be horizontally rotatable for conveying in its rotational direction objects to be aligned which are supplied onto the top surface thereof and a guide mechanism provided above the rotary table not to be rotatable, the device being configured so that the objects to be aligned are aligned in a line and fed to the outside by the rotation of the rotary table and the action of the guide mechanism.

### BACKGROUND ART

The aligning and feeding device is attached to, for example, an automatic inspection device or an automatic wrapping device, and feeds supplied objects to be inspected or wrapped (objects to be aligned) to the automatic inspection or wrapping device (the outside), which is the next process, after making their orientations the same and aligning them in a line. As specific examples of the objects to be inspected or wrapped, tablets, capsules, sweets such as candies, washers, buttons and batteries, which are comparatively small objects, can be given.

As such an aligning and feeding device, conventionally, a device disclosed in the Japanese Utility Model Application Publication No. 3-95315 has been known.

As shown in FIG. 9, an aligning and feeding device 50 comprises a turntable (rotary table) 51 provided to be rotatable about a central axis of rotation extending in the vertical direction, a rotation drive mechanism (not shown) for supporting and rotating the turntable 51 in the direction indicated by the arrow at a certain speed, an arc-shaped peripheral guide 52 disposed above the periphery of the turntable 51, a feed-out guide 53 connected the guide end point of the peripheral guide 52, first, second and third guide plates (guide plates) 57, 58, 59 arranged from the center of rotation of the turntable 51 toward the periphery thereof, a restricting member 61 for restricting the height direction of objects to be aligned H, a removing mechanism 62 for returning the objects to be aligned H toward the center of the turntable 51, and other components.

The first, second and third guide plates 57, 58, 59 are each supported by a support member 60 which is provided at the central position of rotation of the turntable 51 not to be rotatable, and guide, toward the periphery of the turntable 51, the objects to be aligned H which have been supplied onto the turntable 51 by a supply device 80 and are being conveyed in the direction indicated by the arrow.

The peripheral guide 52 is formed so that the distance between the inner face (inner peripheral surface) thereof and the central axis of rotation of the turntable 51 is gradually reduced from the vicinity of the central portion thereof toward the guide end point, and the peripheral guide 52 aligns the objects to be aligned H guided to the periphery of the turntable 51 by the first, second and third guide plates 57, 58, 59 while guiding them along its inner face which is a guide face.

The feed-out guide 53 comprises a first guide member 54 with a straight line shape which has one end connected to the guide end point of the peripheral guide 52 and the other end extending toward the outside of the turntable 51, and a second guide member 55 which has similarly a straight line shape and which is arranged parallel to the first guide member 54 in the same horizontal plane and facing the first guide member 54 at a predetermined distance, and the feed-out guide 53 guides the objects to be aligned H which have been brought into sliding contact with the inner peripheral surface of the peripheral guide 52 and aligned in a line into the gap between the first guide member 54 and the second guide member 55, and guides them toward the outside of the turntable 51. The first guide member 54 is longer in length than the second guide member 55, and the one end of the first guide member 54 extends closer to the peripheral guide 52 than the end of the second guide member 55 and is connected to the guide end point of the peripheral guide 52.

The restricting member 61 is made of a plate-shaped member and is disposed from the guide end point of the peripheral guide 52 to the one end of the first guide member 54 above the turntable 51 with a certain distance therefrom, and restricts the height direction of the objects to be aligned H which have been aligned by the peripheral guide 52 and lets only the objects to be aligned H arranged in one layer pass therethrough.

The removing mechanism 62 comprises a rotary roller 63 provided between the restricting member 61 and the second guide member 55 to be rotatable about a central axis of rotation extending along the vertical direction, a rotation drive mechanism (not shown) for rotating the rotary roller 63 in the direction opposite to the rotational direction of the turntable 51 (in the direction directed by the arrow) and other components, and the objects to be aligned other than the objects to be aligned H which are being conveyed in sliding contact with the first guide member 54 (the objects to be aligned to be removed) are flipped by the rotary roller 63 and thereby moved toward the center of the turntable 51.

According to the conventional aligning and feeding device 50 configured as described above, first of all, the objects to be aligned H are supplied from the supply device 80 onto the turntable 51 which is rotated by the rotation drive mechanism (not shown) in the direction indicated by the arrow. The supplied objects to be aligned H are conveyed in the rotational direction of the turntable 51 due to the rotation thereof, guided by the first and second guide plates 57 and 58 and thereby moved toward the periphery of the turntable 51, and then aligned in about one to three lines along the inner face of the peripheral guide 52.

The objects to be aligned H thus aligned subsequently pass under the restricting member 61 and they are arranged to lie in one layer by the restricting member 61 at this time, and thereafter, the objects to be aligned H which are to be removed are flipped by the rotary roller 63 toward the center of the turntable 51. Thus, the objects to be aligned H are aligned in one layer and one line.

The objects to be aligned H aligned in one layer and one line are guided into the gap between the first guide member 54 and the second guide member 55 through a discharge portion 56 of the feed-out guide 53, and fed out toward the outside of the turntable 51.

### CITATION LIST

Patent Literature

Patent Document 1: Japanese Utility Model Application Publication No. 3-95315

### SUMMARY OF INVENTION

### Technical Problem

However, the objects to be inspected or wrapped as described above include objects having a non-directional, point-symmetric plane shape such as a circle, as shown in FIG. 9, and also objects having the dimensional ratio of length to width (the ratio of length dimension L to width dimension W) which is not an equal ratio (not the same dimension) like an IC chip as shown in FIGS. 10A and 10B. In the case of these objects, the conventional aligning and feeding device 50 as described above has a problem that it is not capable of aligning these objects in a line with their directions made the same (for example, oriented to the longitudinal direction).

That is, although the above-described first, second and third guide plates 57, 58, 59 each guide the objects to be aligned H toward the peripheral guide 52, because the objects to be aligned H have a poor chance to touch the guide plates 57, 58, 59, some types of guide plates 57, 58, 59 cannot make the directions (orientations) of the objects to be aligned H the same. As a result, the objects to be aligned H which have been gathered to the peripheral guide 52 have different orientations as shown in FIG. 11.

Further, for this reason, as shown in FIG. 11, such a problem arises that the objects to be aligned H being conveyed clog the discharge portion 56 of the feed-out guide 53 and remain there.

The present invention has been achieved in view of the above-described circumstances, and an object thereof is to provide an aligning and feeding device capable of reliably aligning even objects having a plane shape with an unequal ratio of length to width longitudinally and feeding them to the outside.

### Solution to Problem

The present invention, for achieving the above-described object, relates to an aligning and feeding device capable of aligning objects to be aligned having a plane shape with an unequal ratio of length to width longitudinally and feeding them to the outside, the aligning and feeding device comprising:

a rotary table provided to be horizontally rotatable;

drive means for rotating the rotary table;

a supply mechanism for supplying the objects to be aligned onto the rotary table; and

a guide mechanism provided above the rotary table for defining a conveying path for the objects to be aligned which are conveyed by the rotary table,

wherein

the guide mechanism has at least an introduction guide, first pair of alignment guides and second pair of alignment guides and pair of discharge guides each having a guide face with which the objects to be aligned are brought into sliding contact and being disposed in sequence from the upstream side to the downstream side of the conveying path;

the introduction guide is arranged so that a start point of its guide face is positioned closer to the center of the rotary table than a supply position of the supply mechanism and an end point of its guide face is positioned closer to the periphery of the rotary table than the supply position of the supply mechanism, and is disposed so as to guide the objects to be aligned supplied by the supply mechanism toward the outer periphery of the rotary table;

the first pair of alignment guide is configured with a first outer guide being disposed at the downstream side of the introduction guide so that a start point of its guide face is positioned closer to the periphery of the rotary table than an end point thereof and its guide face intersects the conveying path on which the objects to be aligned fed out from the introduction guide are conveyed, and a first inner guide being disposed at the downstream side of the first outer guide so that a start point of its guide face is positioned closer to the center of the rotary table than an end point thereof and its guide face intersects the conveying path on which the objects to be aligned fed out from the first outer guide are conveyed;

the second pair of alignment guide is configured with a second outer guide being disposed at the downstream side of the first inner guide so that a start point of its guide face is positioned closer to the periphery of the rotary table than an end point thereof and its guide face intersects the conveying path on which the objects to be aligned fed out from the first inner guide are conveyed, and a second inner guide being disposed at the downstream side of the second outer guide so that a start point of its guide face is positioned closer to the center of the rotary table than an end point thereof and its guide face intersects the conveying path on which the objects to be aligned fed out from the second outer guide are conveyed; and

the pair of discharge guide is configured with an outer discharge guide having a guide face on the side of the center of the rotary table and being disposed at the downstream side of the second inner guide so that its guide face intersects the conveying path on which the objects to be aligned fed out from the second inner guide are conveyed and extends to the outside of the rotary table, and an inner discharge guide having a guide face on the side of the periphery of the rotary table and being provided so that its guide face faces the guide face of the outer discharge guide at such a distance therefrom that the objects to be aligned which have been aligned in a line by the second inner guide longitudinally can pass therethrough and its guide face extends to the outside of the rotary table, the pair of discharge guide being configured to guide the objects to be aligned fed out from the second outer guide into the gap between the outer discharge guide and the inner discharge guide to discharge them to the outside.

According to this aligning and feeding device, the objects to be aligned which have been supplied on the rotary table by the supply mechanism are conveyed in the rotational direction of the rotary table due to the rotation thereof. They are initially brought into contact with the guide face of the introduction guide and guided along the guide face toward the outer periphery of the rotary table, and then they are fed out at the guide end point thereof.

Subsequently, the objects to be aligned which have been fed out from the introduction guide are conveyed to the first pair of alignment guides. They are brought into contact with the guide face of the first outer guide and guided along the guide face toward the center of the rotary table, and then they are fed out at the guide end point thereof. Thereafter, they are brought into contact with the guide face of the first inner guide and guided along the guide face toward the outer periphery of the rotary table, and then they are fed out at the guide end point thereof.

Subsequently, the objects to be aligned which have been fed out from the guide end point of the first inner guide are conveyed to the second pair of alignment guides. Similarly, in the second pair of alignment guides, the objects to be aligned are brought into contact with the guide face of the second outer guide and guided along the guide face toward the center of the rotary table, and then they are fed out at the guide end point thereof. Thereafter, they are brought into contact with the guide face of the second inner guide and guided along the guide face toward the outer periphery of the rotary table, and then they are fed out at the guide end point thereof.

Thus, the objects to be aligned which have been supplied on the rotary table and are in a free orientation (state) are brought into contact repeatedly at least four times, that is, brought into contact in sequence with the first outer guide, the first inner guide, the second outer guide and the second inner guide, in such a manner as described above, and thereby they are arranged to be in such an orientation that their longitudinal directions are along the conveying direction, which is the most stable orientation with respect to the conveying direction, and aligned in a line due to impact caused at that time, although only a little, and due to friction between them and the guide faces.

The objects to be aligned thus aligned in a line are subsequently guided into the gap between the outer discharge guide and the inner discharge guide of the pair of discharge guides, and are guided by the guide faces thereof and discharged to the outside.

It is preferable that, where the width dimension that is the shorter dimension of the object to be aligned is defined as W and the length dimension that is the longer dimension thereof is defined as L, a radius difference B between the position of the guide end point of the second outer guide and the position of the guide start point of the second inner guide in a radial direction around the center of rotation of the rotary table satisfies the following equation:

W<B<L, and

a radius difference A between the position of the guide end point of the first outer guide and the position of the guide start point of the first inner guide in the radial direction is larger than the radius difference B (B<A).

Further, it is more preferable that, where the radius of the position of the guide start point of the first inner guide is defined as R₁ and the radius of the position of the guide start point of the second inner guide is defined as R₂, the radius differences A and B are set so as to satisfy the following equation:

A=B×R₂/R₁.

Setting the radius difference B so as to satisfy the relationship W<B<L makes it possible to feed out the objects to be aligned in a state being reliably aligned in a line toward the pair of discharge guides, and setting the radius difference A so as to satisfy the relationship A>B, in particular, A=B×R₂/R₁ makes it possible to feed out from the pair of first alignment guides toward the second pair of alignment guides the objects to be aligned in such an appropriate amount that the objects to be aligned can be easily aligned in a line at the second pair of alignment guides.

Means for detecting the objects to be aligned which have been fed out from the second inner guide and are in a state of not being aligned and returning them toward the center of the rotary table may be provided between the second inner guide and the outer discharge guide.

The return means can be configured with a first detecting sensor having a detection area set closer to the periphery than the conveying path on which the objects to be aligned having been aligned in a line by the second inner guide and fed out therefrom are conveyed, and detecting the objects to be aligned being conveyed in a state not being aligned, and a first collecting mechanism having a first discharge nozzle provided outside at least the conveying path at the downstream side of the detection area of the first detecting sensor for discharging pressurized fluid toward the center of the rotary table, and discharging pressurized fluid from the first discharge nozzle when a detection signal is received from the first detecting sensor and collecting the objects to be aligned being in a state not being aligned toward the center of the rotary table by means of the pressurized fluid discharged.

As described above, the objects to be aligned which have been fed out from the second pair of alignment guides are basically aligned in a line. However, it is impossible to completely remove the possibility that the objects to be aligned are fed out in a state not being aligned or are brought into a state not being aligned after being fed out due to any factor. Therefore, providing the first detecting sensor and the first collecting mechanism makes it possible to remove the objects to be aligned being conveyed in a state not being aligned from the conveying path and further to return them toward the center of the rotary table.

Therefore, it is possible to prevent a problem that the objects to be aligned which are not aligned are guided to the pair of discharge guides and clog it from arising.

Further, a third pair of alignment guides may be provided between the first pair of alignment guides and the second pair of alignment guides. The third pair of alignment guides is configured with a third outer guide being disposed at the downstream side of the first inner guide so that a start point of its guide face is positioned closer to the periphery of the rotary table than an end point thereof and its guide face intersects the conveying path on which the objects to be aligned fed out from the first inner guide are conveyed, and a third inner guide being disposed at the downstream side of the third outer guide so that a start point of its guide face is positioned closer to the center of the rotary table than an end point thereof and its guide face intersects the conveying path on which the objects to be aligned fed out from the third outer guide are conveyed. In this case, the second outer guide is disposed at the downstream side of the third inner guide so that its guide face intersects the conveying path on which the objects to be aligned fed out from the third inner guide are conveyed.

Providing the third pair of alignment guides makes it possible to increase the frequency that the objects to be aligned are brought into contact with the guide faces, enabling the objects to be aligned to be more reliably aligned in a line.

Furthermore, when forming the guide face of the third inner guide in a wave shape in a plane view, it possible to further increase the frequency that the objects to be aligned are bought into contact with the guide faces, enabling the objects to be aligned to be much more reliably aligned in a line.

A second detecting sensor and a second collecting mechanism may be further provided, the detecting sensor being arranged in front of the portion where the objects to be aligned are guided into the gap between the pair of discharge guides to be discharged, having a detection area set closer to the center than the conveying path on which the objects to be aligned which is aligned in a line and guided by the outer discharge guide are conveyed, and detecting the objects to be aligned remain in front of the discharge portion, the second collecting mechanism having a second discharge nozzle which is arranged outside at least the conveying path on which the objects to be aligned being guided by the outer discharge guide are conveyed in the vicinity of the detection area of the second detecting sensor and which discharges pressurized fluid toward the center of the rotary table, and discharging pressurized fluid from the second discharge nozzle when a detection signal is received from the second detecting sensor and collecting the objects to be aligned which remains toward the center of the rotary table by means of the pressurized fluid discharged.

The objects to be aligned which have been fed out from the second pair of alignment guides and guided by the outer discharge guide are basically aligned in a line by the outer discharge guide. However, the alignment state thereof may be disordered due to any factor. In this case, the objects to be aligned cannot be introduced smoothly into the gap between the pair of discharge guides, thereby causing a state where the objects to be aligned clog the gap and remain there. Such remaining can be dissolved by, as described above, discharging pressurized fluid from the second discharge nozzle and thereby blowing off the objects to be aligned which remain toward the center of the rotary table to collect them.

Further, the second collecting mechanism may be configured to discharge pressurized fluid from the second discharge nozzle for a certain period of time. Furthermore, the second collecting mechanism may be configured to, in a case where the detection signal from the second detecting sensor is still received after the pressurized fluid is discharged for the certain period of time, re-discharge pressurized fluid from the second discharge nozzle for a certain period and perform such re-discharge at least once. When thus configured, it is possible to more reliably dissolve such remaining as described above.

When the objects to be aligned are caught between the pair of discharge guides and remain there, it is possible that the remaining cannot be dissolved only by discharging pressurized fluid from the second nozzle. In this case, that is, in the case where the detection signal is still output from the second detecting sensor even after the discharge operation (including the re-discharge operation) is performed by the second collecting mechanism, it is advantageous to rotate the rotary table in the reverse direction for a certain period of time or by a certain angle and then rotate it in the forward direction by means of the drive means. The balance of the objects to be aligned being caught and remaining is broken by rotating the rotary table in the reverse direction and the remaining caused therefrom can be dissolved.

### Advantageous Effects of Invention

As described above, according to the aligning and feeding device of the present invention, it is possible to align objects to be aligned having a plane shape with unequal ratio of length to width longitudinally in a line and feed them to the outside.

### BRIEF DESCRIPTION OF DRAWINGS

FIG. 1 is a plane view showing major components of an aligning and feeding device according to one embodiment of the present invention;

FIG. 2 is a plane view showing the major components of the aligning and feeding device in FIG. 1 without the holding plate;

FIG. 3 is an enlarged view showing the portion A in FIG. 2 in an enlarged manner;

FIG. 4 is a front view of FIG. 3;

FIG. 5 is an enlarged view showing the portion B in FIG. 2 in an enlarged manner;

FIG. 6 is a front view of FIG. 5;

FIG. 7 is a sectional view seen from the direction indicated by arrow C in FIG. 2;

FIG. 8A is a front view of a second discharge nozzle as viewed from the center of the rotary table toward the periphery thereof according to other embodiment of the present invention;

FIG. 8B is a sectional view taken along arrow F-F in FIG. 8;

FIG. 9 is a plane view showing an aligning and feeding device according to an example of conventional device;

FIG. 10A is a plane view showing an example of the objects to be aligned which can be aligned by the aligning and feeding device of the present invention;

FIG. 10B is a side view of FIG. 10A; and

FIG. 11 is an illustration for explaining a problem in the aligning and feeding device of the example of conventional device.

### DESCRIPTION OF EMBODIMENTS

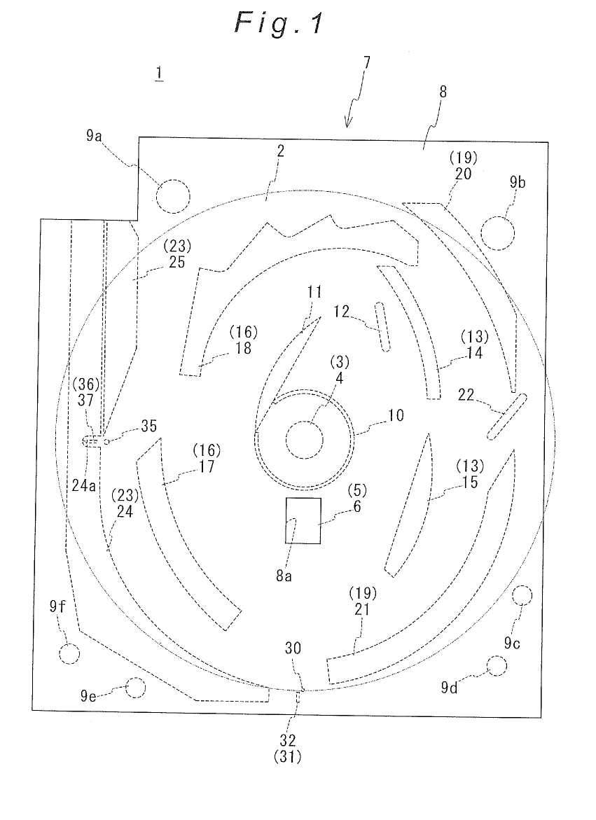

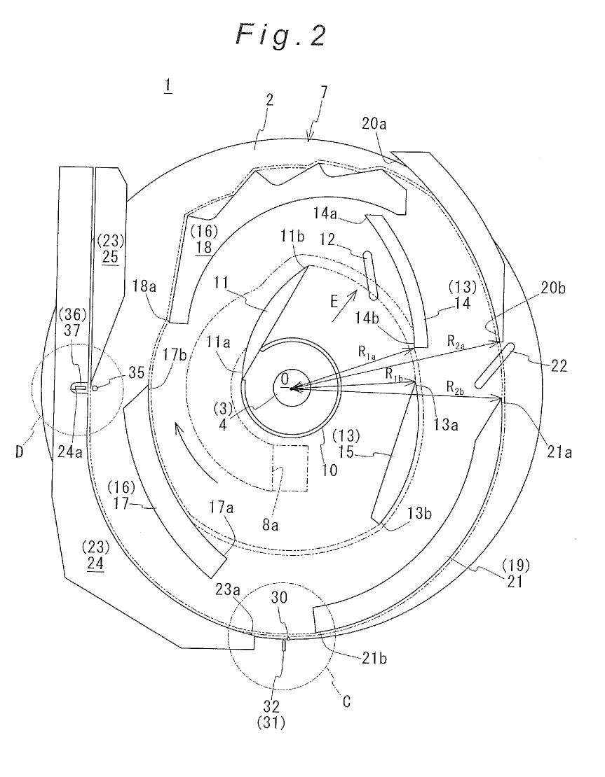

Hereinafter, a preferable embodiment of the present invention will be explained with reference to the drawings. FIG. 1 is a plane view showing major components of an aligning and feeding device according to the embodiment, and FIG. 2 is a plane view showing the major components in FIG. 1 without a holding plate.

An aligning and feeding device 1 of the embodiment has a base (not shown), a rotary table 2 made of a transparent member and provided on the base (not shown) to be horizontally rotatable, a drive mechanism 3 for rotating the rotary table 2, a supply mechanism 5 for supplying objects to be aligned M onto the rotary table 2, and a guide mechanism 7 provided above the rotary table 2 for defining a conveying path on which the objects to be aligned M are conveyed by the rotary table 2.

The supply mechanism 5 is configured with a hopper 6 connected to a supply port 8a formed in a holding plate 8 which will be described later, a conveying device (for example, a belt conveyer) (not shown) for supplying objects to be aligned M into the hopper 6 and other components, and the objects to be aligned M conveyed by the conveying device (not shown) is thrown into the hopper 6 and then supplied onto the rotary table 2 through the supply port 8a.

The drive mechanism 3 is configured with a rotary shaft 4 connected to the rotary table 2, a drive motor (not shown) for rotating the rotary shaft 4 in the forward and reverse directions, a controller (not shown) for controlling the operation of the drive motor (not shown) and other components, and the objects to be aligned M supplied onto the rotary table 2 are conveyed in the rotational direction (the direction indicated by the arrow) of the rotary table 2 by rotating the rotary table 2.

The guide mechanism 7 has an introduction guide 11, a first pair of alignment guides 13, a second pair of alignment guides 19, a third pair of alignment guides 16, a pair of discharge guides 36, a first restricting guide 12, a second restricting guide 22 and a holding plate 8 for holding these guides, and the holding plate 8 is supported on the base (not shown) by support posts 9a, 9b, 9c, 9d, 9e, 9f.

The introduction guide 11, first pair of alignment guides 13, second pair of alignment guides 19, third pair of alignment guides 16 and pair of discharge guides 36 each have a guide face with which the objects to be aligned M are brought into sliding contact, and they are disposed in sequence from the upstream side to the downstream side of a path along which the objects to be aligned M are to be conveyed. The conveying path is defied by actions of the guide faces.

Described specifically, the introduction guide 11 is arranged so that a start point 11a of its guide face (the outer peripheral surface with an arc shape) is positioned closer to the center of the rotary table 2 (hereinafter, simply described with “closer to the center”) than a supply position of the supply mechanism 5 and an end point 11b of its guide face is positioned closer to the periphery of the rotary table 2 (hereinafter, simply described with “closer to the periphery”) than the supply position.

The first pair of alignment guides 13 is configured with a first outer guide 14 being disposed at the downstream side of the introduction guide 11 so that a start point 14a of its guide face (arc-shaped inner peripheral surface) is positioned closer to the periphery than an end point 14b thereof and its guide face intersects the conveying path on which the objects to be aligned M fed out from the introduction guide 11 are conveyed and a first inner guide 15 being disposed at the downstream side of the first outer guide 14 so that a start point 15a of its guide face (arc-shaped outer peripheral surface) is positioned closer to the center than an end point 15b thereof and its guide face intersects the conveying path on which the objects to be aligned M fed out from the first outer guide 14 are conveyed. It is noted that the start point 15a of the first inner guide 15 has a tip portion formed sharp.

The third pair of alignment guides 16 is configured with a third outer guide 17 being disposed at the downstream side of the first inner guide 15 so that a start point 17a of its guide face (arc-shaped inner peripheral surface) is positioned closer to the periphery than an end point 17b thereof and its guide face intersects the conveying path on which the objects to be aligned M fed out from the first inner guide 15 are conveyed and a third inner guide 18 being disposed on the downstream side of the third outer guide 17 so that a start point 18a of its guide face is positioned closer to the center than an end point 18b thereof and its guide face intersects the conveying path on which the objects to be aligned M fed out from the third outer guide 17 are conveyed. It is noted that the guide face of the third inner guide 18 is formed in a wave shape in a plane view.

The second pair of alignment guides 19 is configured with a second outer guide 20 being disposed at the downstream side of the third inner guide 18 so that a start point 20a of its guide face (arc-shaped inner peripheral surface) is positioned closer to the periphery than an end point 20b thereof and its guide face intersects the conveying path on which the objects to be aligned M fed out from the third inner guide 18 are conveyed and a second inner guide 21 being disposed on the downstream side of the second outer guide 20 so that a start point 21a of its guide face (arc-shaped outer peripheral surface) is positioned closer to the center than an end point 21b and its guide face intersects the conveying path on which the objects to be aligned M fed out from the second outer guide 20 are conveyed. It is noted that the start point 21a of the second inner guide 21 also has a tip portion formed sharp.

Where the radius of the guide end point 14a of the first outer guide 14 and the radius of the guide start point 15a of the first inner guide 15 about the center of rotation ◯ of the rotary table 2 is defined as R₁ₐ, R_{1b}, respectively, and the radius of the guide end point 20a of the second outer guide 20 and the radius of the guide start point 21a of the second inner guide 21 about the center of rotation ◯ of the rotary table 2 is R₂ₐ, R_{2b}, respectively, the first outer and inner guides 14 and 15 and the second outer and inner guides 20 and 21 are each disposed so that a radius difference A between R₁ₐ and R_{1b} and a radius difference B between R₂ₐ and R_{2b} satisfy the following equations:

B<A; and

W<B<L, and

it is in particular preferable that they are disposed so that the radius differences A and B satisfy the following equations:

W<B<L; and

A=B×R_{2b}/R_{1b}.

It is noted that W represents the width dimension of the objects to be aligned M and L represents the length dimension of the objects to be aligned M.

The pair of discharge guides 23 is configured with an outer discharge guide 24 which has a guide face on the side of the center of the rotary table 2 and which is disposed at the downstream side of the second inner guide 21 so that its guide face intersects the conveying path on which the objects to be aligned M fed out from the second inner guide 21 are conveyed and extends (protrude) toward the outside of the rotary table 2, and an inner discharge guide 25 which has a guide face on the side of the periphery of the rotary table 2.

The guide face of the outer discharge guide 24 on the side protruding outward is formed in a straight line and the guide face thereof on the side of the second inner guide 21 is formed in an arc shape. On the other hand, the guide face of the inner discharge guide 25 is formed in a straight line. The outer discharge guide 24 and the inner discharge guide 25 are disposed so that the guide face of the outer discharge guide 24 formed in a straight line and the guide face of the inner discharge guide 25 face each other with such a distance therebetween that the objects to be aligned M can pass therethough.

The above-described introduction guide 11, first outer guide 14, first inner guide 15, second outer guide 20, second inner guide 21, third outer guide 17, third inner guide 18, outer discharge guide 24 and inner discharge guide 25 are hold by the holding plate 8 so that they each have such a small clearance from the top surface of the rotary table 2 that the objects to be aligned M cannot pass therethrough.

Above the center of the rotary table 2, an annular cover body 10 which is similarly held by the holding plate 8 with a small clearance that the objects to be aligned M cannot pass therethrough is provided, and the rotary shaft 4 is surrounded by the cover body 10 and the introduction guide 11.

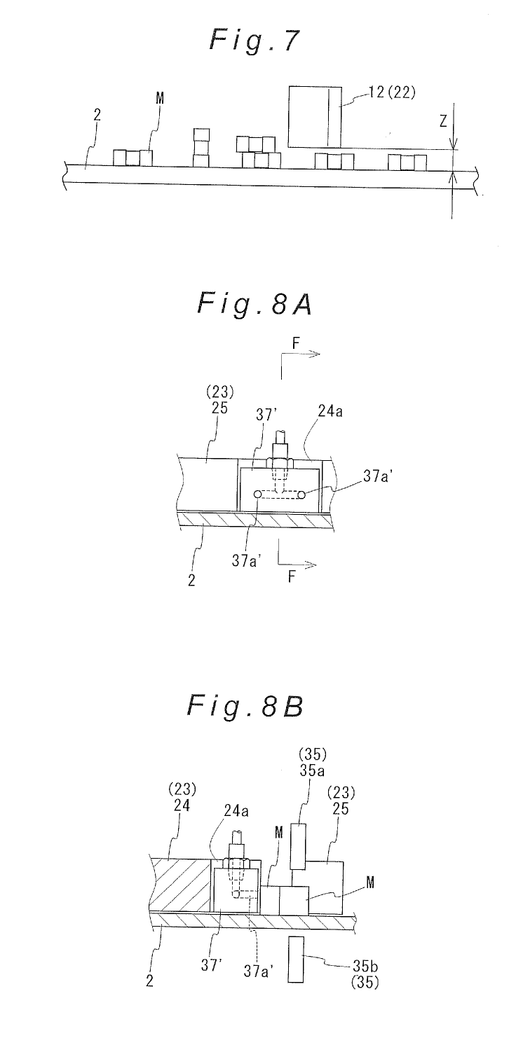

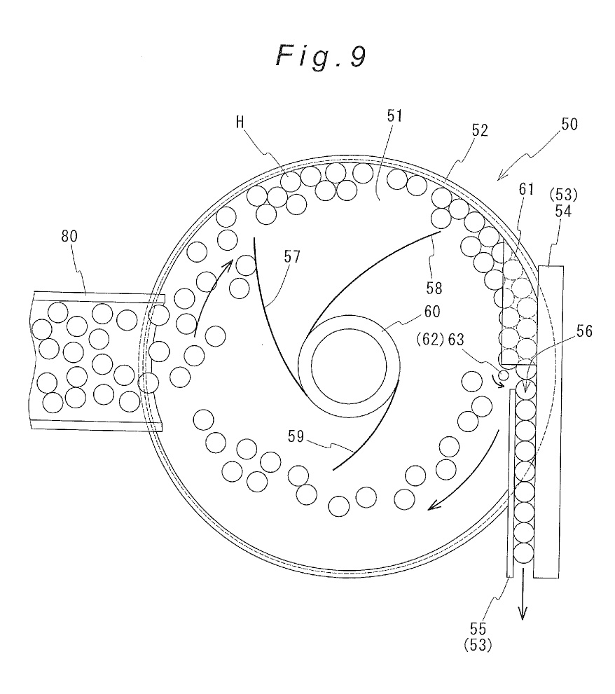

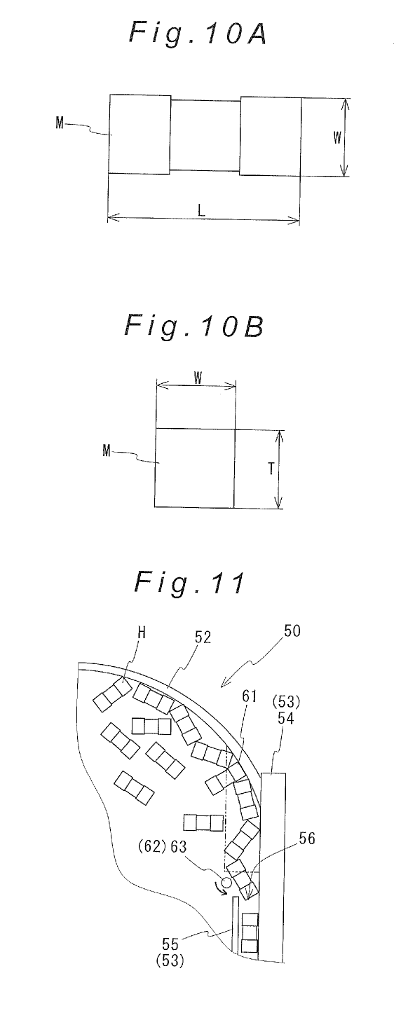

The first restricting guide 12 and the second restricting guide 22 each restrict such a height directional dimension that the objects to be aligned M being conveyed can pass therethough. As shown in FIG. 7, the first restricting guide 12 and the second restricting guide 22 are held by the holding plate 8 so that the gap Z between them and the top surface of the rotary table 2 satisfies the following equations;

Z<2T; and

Z<L.

The first restricting guide 12 is disposed at the downstream side of the introduction guide 11 and the second restricting guide 22 is disposed between the second outer guide 20 and the second inner guide 21. It is noted that T represents the thickness dimension of the objects to be aligned M and L represents the length dimension of the objects to be aligned M.

Between the second inner guide 21 and the outer discharge guide 24, a first detecting sensor 30 for detecting the objects to be aligned M being conveyed in a state not being aligned and a first discharge nozzle 32 configuring a first collecting mechanism 31 are disposed.

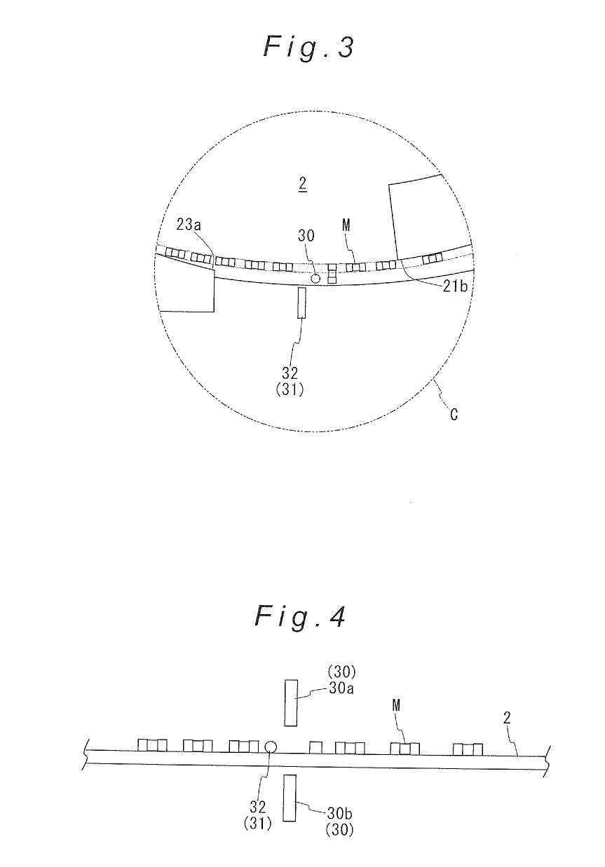

As shown in FIG. 4, the first detecting sensor 30 is a light emitting and receiving sensor which is configured with a light-emitting element 30a and a light-receiving element 30b disposed above and under the rotary table 2 respectively. As shown in FIG. 3, the first detecting sensor 30 has a detection area set closer to the periphery than the conveying path on which the objects to be aligned M aligned in a line by the second inner guide 21 and fed out therefrom are conveyed, and detects the objects to be aligned M which are not aligned in a line longitudinally.

The first discharge nozzle 32 is provided outside at least the conveying path at the downstream side of the detection area of the first detecting sensor 30, and discharges compressed air toward the center of the rotary table 2. The first collecting mechanism 31 discharges compressed air from the first discharge nozzle 32 when receiving a detection signal from the first detecting sensor 30, thereby blowing the objects to be aligned M which are not aligned in a line toward the center of the rotary table 2 to collect them.

Further, in front of the portion where the outer discharge guide 24 and the inner discharge guide 25 face each other (in front of the discharge position), a second detecting sensor 35 for detecting the objects to be aligned M which remain there and a second discharge nozzle 37 configuring a second collecting mechanism 36 are disposed.

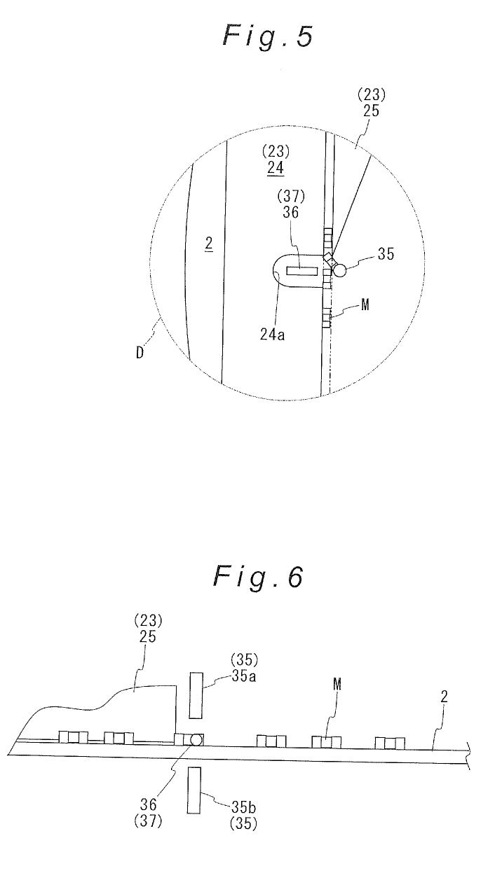

As shown in FIG. 6, the second detecting sensor 35 is a light emitting and receiving sensor which is configured with a light-emitting element 35a and a light-receiving element 35b disposed above and under the rotary table 2 respectively. As shown in FIG. 5, the second detecting sensor 35 has a detection area set closer to the center than the conveying path on which the objects to be aligned M being aligned in a line and guided by the outer discharge guide 24, and detects the objects to be aligned M which remain in front of the discharge position.

The second discharge nozzle 37 is held in a recess portion 24a formed in the outer discharge guide 24 in the vicinity of the detection area of the second detecting sensor 35, that is, is disposed outside the conveying path on which the objects to be aligned M being guided by the outer discharge guide 24, and discharges compressed air toward the center of the rotary table 2.

The second collecting mechanism 36 is configured to, when receiving a detection signal from the second detecting sensor 35, discharge compressed air from the second discharge nozzle 37 for a certain period of time, thereby blowing off the objects to be aligned M which remain toward the center of the rotary table 2 to collect them. Further, the second collecting mechanism 36 is configured to, in a case where still receiving the detection signal from the second detecting sensor 35 even after compressed air is discharging for the certain period of time, re-discharge compressed air from the second discharge nozzle 37 for a certain period of time and perform the re-discharge operation at least once.

The controller (not shown) for the drive mechanism 3 is also configured to receive the detection signal from the second detecting sensor 35, and in a case where still receiving the detection signal even after the second collecting mechanism 36 performs the re-discharge operation, drives and controls the drive motor (not shown) to rotate the rotary table 2 in the reverse direction for a certain period of time or by a certain angle and then rotate it in the forward direction again.

Compressed air is supplied to each of the first and second discharge nozzles 32, 37 from a not-shown supply source.

According to the aligning and feeding device 1 having the above-described configuration, initially objects to be aligned M are supplied onto the rotary table 2 by the supply mechanism 5 through the hopper 6 and the supply port 8a. The supplied objects to be aligned M are conveyed in the rotational direction of the rotary table 2 by the rotary table 2 rotated in the forward direction by the drive mechanism 3.

When the supplied objects to be aligned M reach the introduction guide 11, they are brought into contact with the guide face of the introduction guide 11 and guided along the guide face toward the periphery of the rotary table 2, and are fed out at the guide end point 11b thereof. At this time, the objects to be aligned M are fed out from the guide end point 11b in a state where the moving path on which the objects to be aligned M which have been supplied widely through the supply port 8a move is narrowed gradually by the introduction guide 11.

Thereafter, the objects to be aligned M which have passed through the introduction guide 11 then reach the first restricting guide 12. As shown in FIG. 7, when they pass through the first restricting guide 12, in a case where they are in a state being piled in more than one layer, the objects to be aligned M which are positioned in the layers above the bottom layer touch the first restricting guide 12 and thereby are pushed off, dissolving the state where they are piled. In a case where the objects to be aligned M are in a standing position, they touch the first restricting guide 12 and thereby pushed down. As a result, the objects to be aligned M lying in one layer can pass through the first restricting guide 12. Thus, the objects to be aligned M are conveyed to the first pair of alignment guides 13 after being arranged in one layer in this manner.

When reaching the first pair of alignment guides 13, the objects to be aligned M are initially brought into contact with the guide face of the first outer guide 14 and guided along the guide face toward the center of the rotary table 2, and are fed from at the guide end point 14a thereof in a state where the width of the conveying path is further narrowed.

The objects to be aligned M which have passed through the first outer guide 14 subsequently reach the guide start point 15a of the first inner guide 15 and separated into the inner side and the outer side there. That is, the objects to be aligned M positioned closer to the periphery than the guide start point 15a are guided along the guide face of the first inner guide 15 toward the periphery and the objects to be aligned M positioned closer to the center are returned toward the center of the rotary table 2.

The objects to be aligned M conveyed along the guide face of the first inner guide 15 toward the periphery are conveyed while the distance between the objects to be aligned M adjacent in the conveying direction are gradually widened due to the difference between conveying peripheral velocities thereof, and then they are fed out at the guide end point 15b of the first inner guide 15.

The objects to be aligned M which have passed through the first inner guide 15 in this manner are hereafter conveyed in sequence to the third pair of alignment guides 16 and the second pair of alignment guides 19 in the similar manner.

That is, in the third pair of alignment guides 16, the objects to be aligned M are guided along the guide face of the third outer guide 17 toward the center, and at this time they are conveyed while the distance between them in the conveying direction is gradually narrowed due to the difference between the conveying peripheral velocities thereof. Thereafter, the objects to be aligned M are guided along the guide face of the third inner guide 18 toward the periphery, and at this time they are conveyed while the distance between them in the conveying direction is gradually widened due to the difference between the conveying peripheral velocities thereof and, since the guide face of the third inner guide 18 is formed in a wave shape, they are conveyed to the guide end point 18b while alternating touching and separating from the guide face, and then they are fed out therefrom.

In the second pair of alignment guides 19, the objects to be aligned M are guided along the guide face of the second outer guide 20 toward the center, and at this time they are conveyed while the distance between them in the conveying direction is gradually narrowed due to the difference between the conveying peripheral velocities thereof. Thereafter, the conveying state of the objects to be aligned M is arranged in one layer by passing through the second restricting guide 22, and then they are conveyed to the second inner guide 21.

At the second inner guide 21, the objects to be aligned M are separated into the inner side and the outer side at the guide start point 21a, that is, the objects to be aligned M positioned closer to the periphery than the guide start point 21a are guided along the guide face of the second inner guide 21 toward the periphery and the objects to be aligned M positioned closer to the center are returned toward the center of the rotary table 2.

The objects to be aligned M being guided along the guide face of the second inner guide 21 are conveyed while the distance between them in the conveying direction is gradually widened due to the difference between the conveying peripheral velocities thereof, and then they are fed out from the guide end point 21b thereof.

Thus, the objects to be aligned M supplied onto the rotary table 2 by the supply mechanism 5 are aligned longitudinally in one layer and one line by being conveyed in sequence to the introduction guide 11, the first restricting guide 12, the first pair of alignment guides 13, the third pair of alignment guides 16 and the second pair of alignment guides 19, and they are finally fed out from the second inner guide 21.

The objects to be aligned M which have been supplied onto the rotary table 2 and are in a free orientation (state) are repeatedly brought into contact with the first outer guide 14, the first inner guide 15, the third outer guide 17, the third inner guide 18, the second outer guide 20 and the second inner guide 21 in such a manner as described above, and thereby they are arranged in such an orientation that their longitudinal directions are along the conveying direction, which is the most stable orientation with respect to the conveying direction, and aligned in a line due to impact caused at that time, although only a little, and due to friction between them and the guide faces.

In this embodiment, since the guide face of the third inner guide 18 is formed in a wave shape, the frequency that the objects to be aligned M are brought into contact with the guide faces can be increased, enhancing the alignment effect.

The objects to be aligned M which have been aligned in a line in such a manner as described above are subsequently guided into the gap between the outer discharge guide 24 and the inner discharge guide 25 of the pair of discharge guides 23 and guided by the guide faces thereof and are discharged to the outside.

As described above, according to the aligning and feeding device 1 of the embodiment, it is possible to reliably align the objects to be aligned M in one layer and one line and feed them even if they have a plane shape with an unequal ratio of length to width.

Further, in the embodiment, it is possible to feed out the objects to be aligned M toward the pair of discharge guide 23 in a state that they are reliably aligned in a line because the radius difference A between the radius position of the guide end point 14a of the first outer guide 14 and the radius position of the guide start point 15a of the first inner guide 15 and the radius difference B between the radius position of the guide end point 20a of the second outer guide 20 and the radius position of the guide start point 21a of the second inner guide 21 are set so as to satisfy the following equations;

B<A; and

W<B<L

In particular, when the radius differences A and B are set so as to satisfy the relationship A=B×R_{2b}/R_{1b}, it is possible to feed out from the first pair of alignment guides 13 toward the second pair of alignment guides 19 the objects to be aligned M in such an appropriate amount that they can easily aligned in a line at the second pair of alignment guides 19.

Due to the above action, the objects to be alignment M fed out from the second pair of alignment guide 19 are basically fed out in a state where they are aligned longitudinally in a line. However, it is impossible to completely remove the fact that they are fed out in a state not being aligned in a line or brought into a state not being aligned after being fed out due to any factor.

In the embodiment, the objects to be aligned M which are fed out from the second inner guide 21 in a state not being aligned are detected by the first detecting sensor 30 and compressed air are discharged from the first discharge nozzle 32, thereby blowing off the objects to be aligned M toward the center of the rotary table 2 to collect them. Therefore, it is possible to reliably remove the objects to be aligned M being conveyed in a state not being aligned from the conveying path, and further to collect them toward the center of the rotary table 2.

Therefore, it is possible to prevent such a problem that the objects to be aligned M which are not aligned are guided to the pair of discharge guides 23 and clog it from arising.

In a case where the objects to be aligned M being guided by the outer discharge guide 24 are not aligned in a line or the alignment state is disordered, the objects to be aligned M remain in front of the inner discharge guide 25 (in front of the discharge portion) due to the clogging. In the embodiment, such remaining is detected by the second detecting sensor 35 and compressed air are discharged from the second discharge nozzle 37 for a certain period of time, thereby blowing off the objects to be aligned M which remain there toward the center of the rotary table 2 to collect them. Therefore, it is possible to easily dissolve such remaining. Further, in a case where the detection signal is still received from the second detecting sensor 35 even after compressed air is discharged for the certain time period, the re-discharge operation that compressed air is re-discharged from the second discharge nozzle for a certain period of time is performed at least once, therefore it is possible to reliably dissolve the remaining.

Furthermore, in a case where the objects to be alignment M are caught between the pair of discharge guide 23 and remain there, it is possible that such remaining cannot be dissolved only by discharging compressed air from the second discharge nozzle 37. In the embodiment, in a case where the detection signal is still output from the second detecting sensor 35 even after the re-discharge from the second discharge nozzle 37 is performed, the rotary table 2 is rotated in the reverse direction for a certain period of time or by a certain angle and then is rotated in the forward direction again. Therefore, the balance of the objects to be aligned M is broken by the reverse operation of the rotary table 2 and the remaining caused by the objects to be aligned M being caught can be dissolved. At this time, compressed air may be discharged from the second nozzle 37 to collect the objects to be aligned M being in disorder toward the center of the rotary table 2 at the same time of the reverse operation of the rotary table 2.

Thus, one embodiment of the present invention has been described. However, a specific mode in which the present invention can be implemented is not limited to the above embodiment.

For example, although, in the above embodiment, the second discharge nozzle 37 having a one nozzle hole is provided in front of the discharge portion, it is not limited to such discharge nozzle and may have a plurality of nozzle holes.

In FIGS. 8A and 8B, a second discharge nozzle 37′ having two nozzle holes 37a′, 37a′ aligned in the horizontal direction are shown as an example. According to the second discharge nozzle 37′, it is possible to, in the case where the objects to be aligned clog the discharge position, blow off the objects to be aligned which remain there in a wide range to collect them toward the center of the rotary table 2, and therefore it is possible to more reliably dissolve the clogging.

It is noted that FIG. 8A shows the second discharge nozzle 37′ and other components seen from the center of the rotary table 2 and FIG. 8B is a sectional view taken along arrow F-F in FIG. 8A.

### INDUSTRIAL APPLICABILITY

As described above in detail, the present invention is preferable as a device for aligning objects to be aligned having a plane shape with an unequal ratio of length to width longitudinally and feeding them.

### REFERENCE SIGNS LIST

1 Aligning and feeding device

2 Rotary table

3 Drive means

5 Supply mechanism

7 Guide mechanism

11 Introduction guide

13 First pair of alignment guides

14 First outer guide

15 First inner guide

16 Third pair of alignment guides

17 Third outer guide

18 Third inner guide

19 Second pair of alignment guides

20 Second outer guide

21 Second inner guide

23 Pair of discharge guides

24 Outer discharge guide

25 Inner discharge guide

1. An aligning and feeding device capable of aligning objects to be aligned having a plane shape with an unequal ratio of length to width longitudinally and feeding them to the outside, the aligning and feeding device comprising:
a rotary table provided to be horizontally rotatable;
drive means for rotating the rotary table;
a supply mechanism for supplying the objects to be aligned onto the rotary table; and
a guide mechanism provided above the rotary table for defining a conveying path for the objects to be aligned which are conveyed by the rotary table,
wherein
the guide mechanism has at least an introduction guide, first pair of alignment guides and second pair of alignment guides and pair of discharge guides each having a guide face with which the objects to be aligned are brought into sliding contact and being disposed in sequence from the upstream side to the downstream side of the conveying path;
the introduction guide is arranged so that a start point of its guide face is positioned closer to the center of the rotary table than a supply position of the supply mechanism and an end point of its guide face is positioned closer to the periphery of the rotary table than the supply position of the supply mechanism, and is disposed so as to guide the objects to be aligned supplied by the supply mechanism toward the outer periphery of the rotary table;
the first pair of alignment guide is configured with a first outer guide being disposed at the downstream side of the introduction guide so that a start point of its guide face is positioned closer to the periphery of the rotary table than an end point thereof and its guide face intersects the conveying path on which the objects to be aligned fed out from the introduction guide are conveyed, and a first inner guide being disposed at the downstream side of the first outer guide so that a start point of its guide face is positioned closer to the center of the rotary table than an end point thereof and its guide face intersects the conveying path on which the objects to be aligned fed out from the first outer guide are conveyed;
the second pair of alignment guide is configured with a second outer guide being disposed at the downstream side of the first inner guide so that a start point of its guide face is positioned closer to the periphery of the rotary table than an end point thereof and its guide face intersects the conveying path on which the objects to be aligned fed out from the first inner guide are conveyed, and a second inner guide being disposed at the downstream side of the second outer guide so that a start point of its guide face is positioned closer to the center of the rotary table than an end point thereof and its guide face intersects the conveying path on which the objects to be aligned fed out from the second outer guide are conveyed; and
the pair of discharge guide is configured with an outer discharge guide having a guide face on the side of the center of the rotary table and being disposed at the downstream side of the second inner guide so that its guide face intersects the conveying path on which the objects to be aligned fed out from the second inner guide are conveyed and extends to the outside of the rotary table, and an inner discharge guide having a guide face on the side of the periphery of the rotary table and being provided so that its guide face faces the guide face of the outer discharge guide at such a distance therefrom that the objects to be aligned which have been aligned in a line by the second inner guide longitudinally can pass therethrough and its guide face extends to the outside of the rotary table, the pair of discharge guide being configured to guide the objects to be aligned fed out from the second outer guide into the gap between the outer discharge guide and the inner discharge guide to discharge them to the outside.

2. The aligning and feeding device according to claim 1, wherein, where the width dimension which is the shorter dimension of the objects to be aligned is defined as W and the length dimension that is the longer dimension thereof is defined as L, a radius difference A between the position of the guide end point of the first outer guide and the position of the guide start point of the first inner guide in a radial direction about the center of rotation of the rotary table and a radius difference B between the position of the guide end point of the second outer guide and the position of the guide start point of the second inner guide in the radial direction are set so as to satisfy the following equations:
B<A; and
W<B<L.

3. The aligning and feeding device according to claim 2, wherein, where the radius of the position of the guide start point of the first inner guide about the center of rotation of the rotary table is defined as R₁ and the radius of the position of the guide start point of the second inner guide about the center of rotation of the rotary table is defined as R₂, the radius differences A and B are set so as to satisfy the following equation:
A=B×R₂/R₁.

4. The aligning and feeding device according to claim 1, wherein the aligning and feeding device further comprises:
a first detecting sensor provided between the second inner guide and the outer discharge guide for detecting the objects to be aligned being conveyed in a state not being aligned, the first detecting sensor having a detection area set closer to the periphery than the conveying path on which the objects to be aligned having been aligned in a line by the second inner guide and fed out therefrom are conveyed; and
a first collecting mechanism having a first discharge nozzle which is provided outside at least the conveying path at the downstream side of the detection area of the first detecting sensor and which discharges pressurized fluid toward the center of the rotary table, and discharging pressurized fluid from the first discharge nozzle on receiving a detection signal from the first detecting sensor and collecting the objects to be aligned which are not aligned toward the center of the rotary table by means of the pressurized fluid discharged.

5. The aligning and feeding device according to claim 1, wherein
the guide mechanism has a third pair of alignment guides between the first pair of alignment guides and the second pair of alignment guides;
the third pair of alignment guides is configured with a third outer guide being disposed at the downstream side of the first inner guide so that a start point of its guide face is positioned closer to the periphery of the rotary table than an end point thereof and its guide face intersects the conveying path on which the objects to be aligned fed out from the first inner guide are conveyed, and a third inner guide being disposed at the downstream side of the third outer guide so that a start point of its guide face is positioned closer to the center of the rotary table than an end point thereof and its guide face intersects the conveying path on which the objects to be aligned fed out from the third outer guide are conveyed; and
the second outer guide is disposed at the downstream side of the third inner guide so that its guide face intersects the conveying path on which the objects to be aligned fed out from the third inner guide are conveyed.

6. The aligning and feeding device according to claim 5, wherein the guide face of the third inner guide is formed in a wave shape in a plane view.

7. The aligning and feeding device according to claim 1, wherein the aligning and feeding device further comprises:
a second detecting sensor provided in front of the portion where the objects to be aligned are guided into the gap between the pair of discharge guide to be discharged for detecting the objects to be aligned which remain in front of the discharge portion, the second detecting sensor having a detection area set closer to the center than the conveying path on which the objects to be aligned being aligned in a line and guided by the outer discharge guide are conveyed, and
a second collecting mechanism having a second discharge nozzle which is provided outside at least the conveying path on which the objects to be aligned being guided by the outer discharge guide are conveyed in the vicinity of the detection area of the second detecting sensor for discharging pressurized fluid toward the center of the rotary table, and discharging pressurized fluid from the second discharge nozzle when a detection signal is received from the second detecting sensor and collecting the objects to be aligned which remain toward the center of the rotary table by means of the pressurized fluid discharged.

8. The aligning and feeding device according to claim 7, wherein the collecting mechanism is configured to discharge pressurized fluid from the second discharge nozzle for a certain period of time, and configured to, in a case where the detection signal is still received from the second detecting sensor after the pressurized fluid is discharged for the certain period of time, re-discharge pressurized fluid from the second discharge nozzle for a certain period of time and perform the re-discharge at least once.

9. The aligning and feeding device according to claim 7 or 8, wherein the drive means is configured to, in a case where the detection signal is still received from the second detecting sensor even after the discharge operation is performed by the collecting mechanism, rotate the rotary table in the reverse direction for a certain period of time or by a certain angle and the rotate it in the forward direction again.
